(19) United States
(12) Patent Application Publication
(10) Pub. No.: US 2014/0365269 A1
(43) Pub. Date: Dec. 11, 2014

(54) FAILURE PREDICTION BASED PREVENTATIVE MAINTENANCE PLANNING ON ASSET NETWORK SYSTEM

(71) Applicant: Internationl Business Machines Corporation, Armonk, NY (US)

(72) Inventors: Arun Hampapur, Norwalk, CT (US); Hongfei Li, Briarcliff Manor, NY (US); Yada Zhu, White Plains, NY (US)

(21) Appl. No.: 13/913,828

(22) Filed: Jun. 10, 2013

(51) Int. Cl. G06Q 10/06

(52) U.S. Cl. CPC G06Q 10/0635
USPC 705/7.28

(57) ABSTRACT

There are provided a method, a system and a computer program product for maintaining an asset. The system receives data associated with an one asset and other assets to which the one asset is directly or indirectly physically connected. The system determines, based on the received data, a dependency between the one asset and one or more of the other assets. The system predicts, based on the determined dependency, a failure of the one asset within a future time period.

### BACKGROUND

This disclosure relates generally to maintaining an asset, and particularly to predicting an asset failure.

### BACKGROUND OF THE INVENTION

A methodology for predicting an asset failure considers assets individually and predicts failure risk of each asset by incorporating only its own attributes. The conventional methodology ignores the fact that each asset has to operate in a network and/or cannot operate independently.

### SUMMARY

There are provided a method, a system and a computer program product for maintaining an asset. The system receives data associated with one asset and other assets to which the one asset is directly or indirectly physically connected. The system determines, based on the received data, a dependency between the one asset and one or more of the other assets. The system predicts, based on the determined dependency, a failure of the one asset within a future time period.

In order to determine the dependency, the system correlates a failure and an operation of the one or more of the other assets to a failure risk of the one asset.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 illustrates an example dependency between assets and further illustrates constraints;

FIG. 2 illustrates a flowchart that describes a method for maintaining an asset;

FIG. 3 illustrates examples of a computing system that can run the method illustrated in FIG. 2;

FIG. 4 illustrates example dependencies between assets; and

FIG. 5 illustrates an example graph that depicts a relationship between a spatial distance between assets and a corresponding failure risk of these assets.

### DETAILED DESCRIPTION

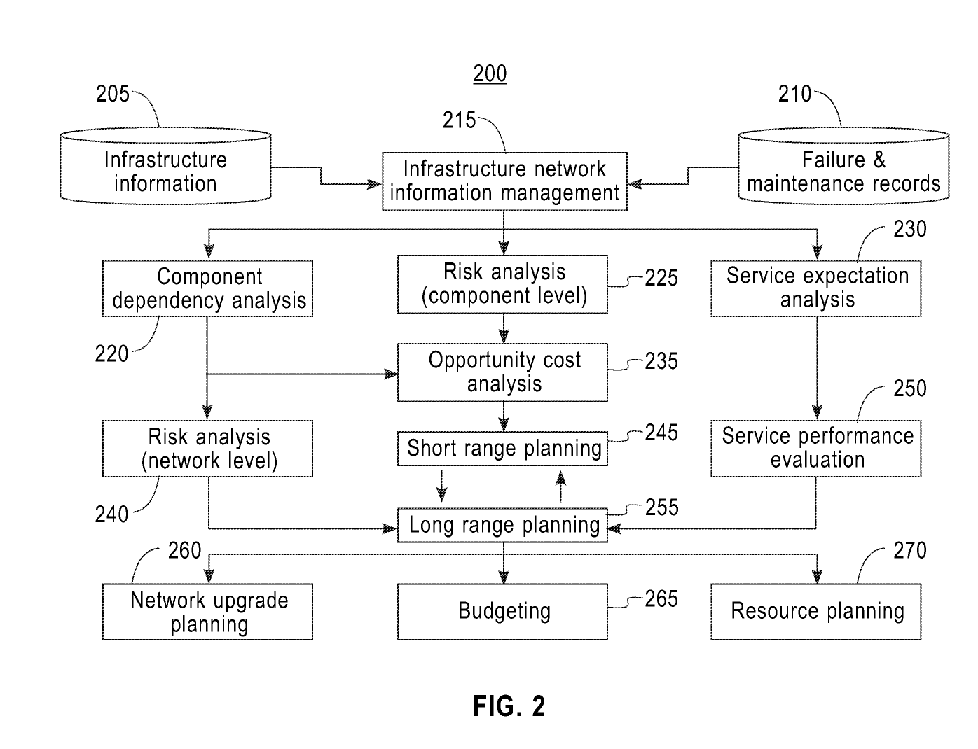

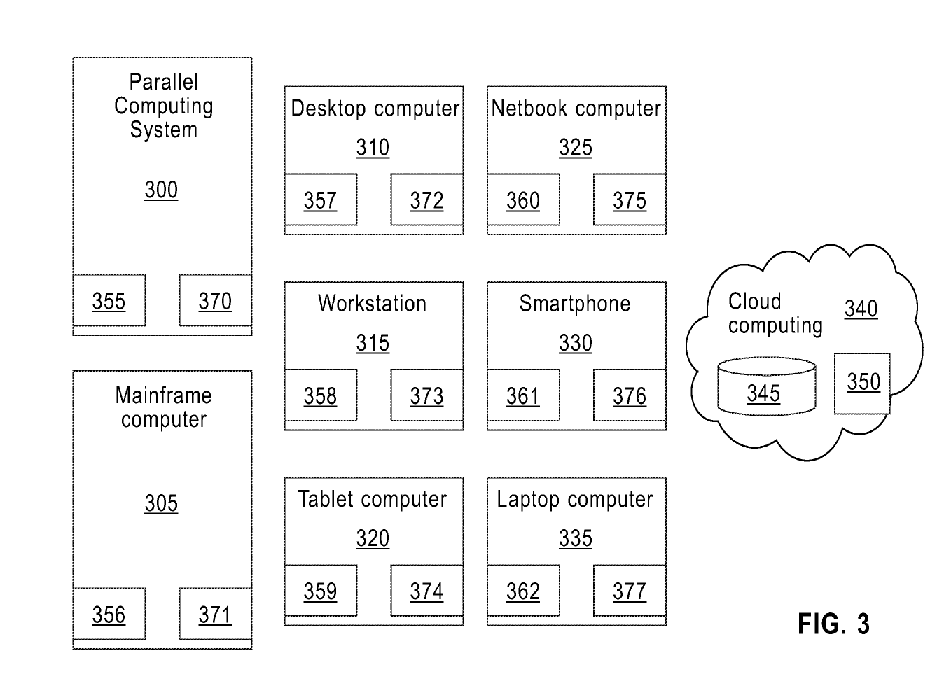

There is provided a method, a system and a computer program product for managing an asset. An asset refers to herein a part of an infrastructure, e.g., a physical network, which interoperates with other assets. An asset and other assets may be physically indirectly or directly connected. An asset includes, but is not limited to: a fire hydrant, a pipeline, and a valve. FIG. 2 illustrates a flowchart that describes a method for maintaining an asset. FIG. 3 illustrates examples of a computing system that can run the method shown in FIG. 2. These example computing systems may include, but are not limited to: a parallel computing system 300 including at least one processor 355 and at least one memory device 370, a mainframe computer 305 including at least one processor 356 and at least one memory device 371, a desktop computer 310 including at least one processor 357 and at least one memory device 372, a workstation 315 including at least one processor 358 and at least one memory device 373, a tablet computer 320 including at least one processor 356 and at least one memory device 374, a netbook computer 325 including at least one processor 360 and at least one memory device 375, a smartphone 330 including at least one processor 361 and at least one memory device 376, a laptop computer 335 including at least one processor 362 and at least one memory device 377, or a cloud computing system 340 including at least one storage device 345 and at least one server device 350.

Returning to FIG. 2, the computing system receives, from one or more databases, data 215 associated with one asset and other assets to which the one asset is directly or indirectly physically connected. In one embodiment, the one asset and the other assets may be same types of assets. In another embodiment, the one asset and the other assets may be different types of assets. A database 205 may store data associated with structures and physical connections associated with the one asset and the other assets. Another database 210 may store data associated with failure(s) and maintenance(s) of the one asset and the other assets. The received data 215 may include, but is not limited to: data associated with structures (e.g., asset age, asset materials, etc.) and physical connections associated with the one asset and the other assets, data records associated with failure(s) and maintenance(s) of the one asset and the other assets, and data associated with management of the one asset and the other assets. For example, a failure record of an asset may indicate how long that asset has been used from an installation date of the asset to a failure of the asset.

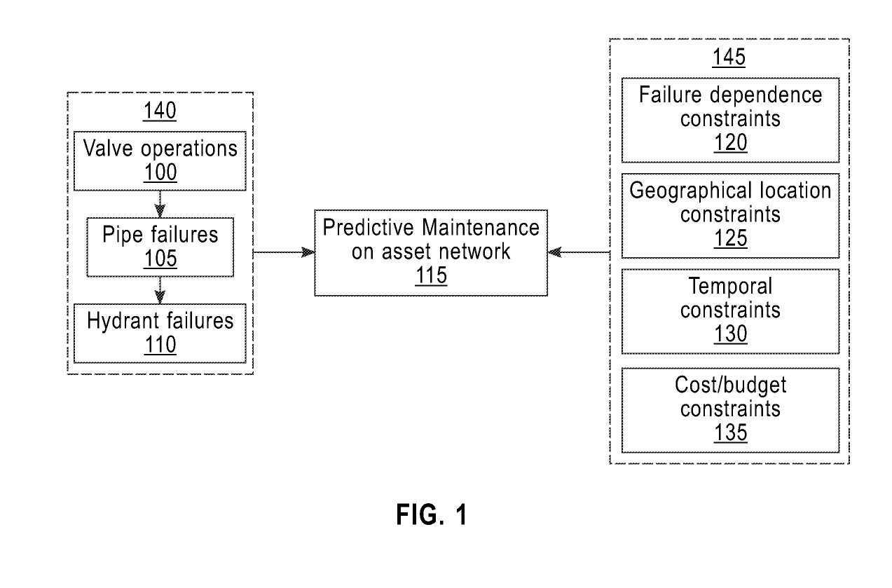

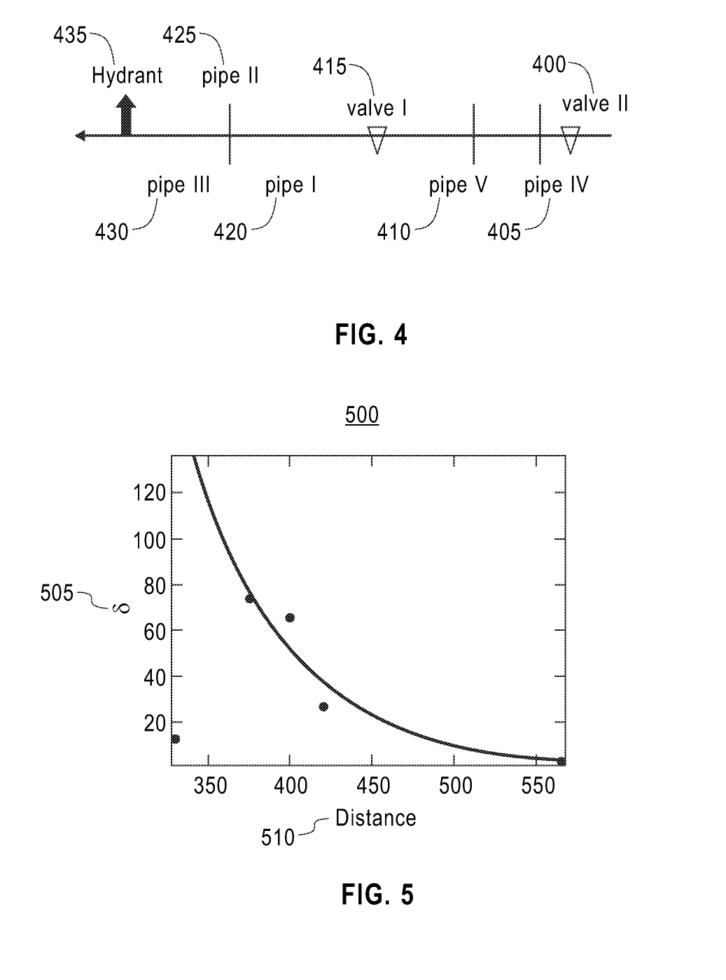

At 220, the computing system determines, based on the received data 215, a dependency between the one asset and one or more of the other assets. For example, the received data 215 may indicate physical connections between the one asset and the other assets. FIG. 4 illustrates an example of dependencies between interconnected assets. An operation of a water valve I (415) impacts a water flow in a water pipe I (420), a water pipe II (425) and a water pipe III (430). Thus, the operation of the water valve I (415) affects the operation of the water pipes I-III (420-430). An operation (e.g., break, leak, etc.) of a water pipe III (430) impacts water availability and water pressure of a fire hydrant I (435). Thus, the operation of the water pipe III (430) affects an operation of the fire hydrant I (435). Furthermore, the operation of the fire hydrant I (435) depends on water pipes I-V (405-410 and 420-430) that provide water to the fire hydrant I (435). Water valves I-II (400 and 415) control a water flow of the water pipes I-V (405-410 and 420-430). Therefore, the operation of the fire hydrant I (435) depends on the operation of the valves I-II (400 and 415) and the operation of the water pipes I-V (405-410 and 420-430). In other words, as shown in FIG. 1, the dependency 140 between the assets may indicate, for example, that the operations of the water valves 100 may affect the operation of one or more of the water pipes 105. The failure of the one or more the water pipes 105 may cause a failure of the fire hydrant I 110.

In one embodiment, in order to determine the dependency between assets in a network, the computing system performs a network flow analysis or a minimum-cut-set analysis on the received data 215. A network flow analysis refers to an analysis of a gas or liquid flow through a pipeline network to determine a liquid flow rate or a liquid pressure in a specific portion of a corresponding physical network. FIG. 4, which is described above, illustrates an example network flow analysis: the operation of the fire hydrant I (435) depends on the operation of the water valves I-II (400 and 415) and the operation of the water pipes I-V (405-410 and 420-430). The minimum-cut-set analysis determines a smallest set of events that shall occur in order to fail a node in a physical network. For example, in FIG. 4, a failure of the pipe III (430) results in the failure of the hydrant I (435).

In another embodiment, in order to determine the dependency between assets in a network, the computing system correlates a failure or an operation of one or more of other assets to a failure risk of the one asset. For example, in FIG. 4, a failure of the pipe III (430) results in a failure of the fire hydrant I (435).

Returning to FIG. 2, at 240, as part of a network level risk analysis, in order to correlate a failure or an operation of the one or more assets to a failure risk of the one asset, the computing system computes a hazard function associated with the one asset according to hᵢ(t)=hⱼ(t)ƒ(δ(Dᵢⱼ)), where i indicates an identification of the one asset, j indicates an identification of another asset among the other assets, t indicates a future time period, h ( ) is a hazard function, ƒ ( ) is a function whose output is a positive value, δ ( ) is a function that associates a spatial distance between the one asset and the another asset with the failure risk of the one asset. An example hazard function that can be used in a situation depicted in FIG. 4 may include, but is not limited to: h₁(t)=h₂(t)exp(β^{T}Z+exp(−d₁₂/ρ)) where h₁(t) is a hazard function of valve I (415), h₂ (t) is a hazard function of pipe I (420), Z is a vector of asset attributes, e.g. pipe material and diameter, β^{T} and ρ are coefficients that can be estimated from historical failure data by using, for example, maximum likelihood estimate or Bayesian estimator, and d₁₂ is the distance measure between valve I (415) and pipe I (420). FIG. 5 illustrates a graph that depicts a relationship between the spatial distance 510 (x-axis) and the failure risk (y-axis) of the one asset 505. As shown in FIG. 5, as the spatial distance 510 between the one asset and the another asset is closer, there may be higher failure risk on the one asset due to a failure of the another asset. As the spatial distance 510 between the one asset and the another asset is farther, there may be a lower failure risk on the one asset due to the failure of the another asset.

In one embodiment, in order to determine the dependency between the one asset and the one or more of the other assets, the computing system may determine one or more constraints (e.g., constraints 145 shown in FIG. 1) associated with the one asset and the one or more of the other assets. The one or more constraints 145 include, but are not limited to: failure dependence constraints 120, geographical location constraints 125, temporal constraints 130 and cost/budget constraints 135.

The failure dependence constraints 120 refer to ways in which a failure or an operation of the one or more of the other assets affects or impacts the failure risk of the one asset. An example of the failure dependence constraints includes, but is not limited to: as shown in FIG. 4, a failure risk of the fire hydrant I (435) is correlated to other assets to which the fire hydrant I (435) is connected, e.g., water valves I-II (400 and 415) and water pipes I-III (420-430).

The geographical location constraints 125 include, but are not limited to: physical connections between assets in a physical network or physical connections between physical networks. Suppose that i and j are two physical assets in a water network. A geographical location of each asset is represented by a corresponding longitude position and a corresponding latitude position at which the each asset is located. The computing system can calculate the geographical distance between the two assets, e.g., dᵢⱼ=\sqrt{(xᵢ−xⱼ)²+(yᵢ−yⱼ)²}, where xᵢ is a longitude coordinate of the asset i, yᵢ is a latitude coordinate of the asset j, xⱼ is a longitude coordinate of the asset j, and yⱼ is a latitude coordinate of the asset j. The computing system sets a geographical constraint dᵢⱼ≧D to schedule a maintenance action on one or more of the two assets, where D is a given threshold, e.g., 1 mile, etc.

The temporal constraints 130 include, but are not limited to: (1) measuring, e.g., by solving the hazard function described above, a failure risk on the one asset, which depends on a failure or an operation of the one or more of the other assets, within a pre-determined time period, e.g., one month; and (2) correlating, e.g., by solving the hazard function described above, a failure pattern of the one asset and a failure pattern of the one or more of the other assets: if two assets are adjacent to each other, failure patterns of those two assets may be similar. Cost/budget constraints 135 refer to a maximum limit of cost that can be spent to inspect or repair the one asset or the one or more of the other assets.

Based on the determined dependency and the correlation, the computing system predicts a failure risk of the one asset within the future time period t. In one embodiment, in order to predict the failure risk of the one asset within the future time period, the computing system solves the hazard function described above. The hazard function computes the failure risk of the one asset i at the future time period t according to a failure risk of the another asset j at the future time period t and the spatial distance between the one asset i and the another asset j. In one embodiment, the computing system predicts a failure of each asset in a physical network, e.g., by solving the hazard function described above.

For example, a water utility company may be interested in a risk assessment of its assets including, but not limited to: fire hydrants, water pipes and water valves. A failure prediction of the one asset depends on a failure risk of its adjacent assets to which the each asset is physically connected indirectly or directly. The computing system may cluster the one asset and the adjacent assets as one cluster because the one asset and the adjacent assets are affected each other.

At 225, the computing system computes, based on the received data 225, a failure risk of each asset, e.g., based on each asset's own properties, for example, age and material of the each asset. For example, the received data may include a specification of each asset and a prior failure record of each asset. The specification of each asset may describe an expected life time of each asset. The prior failure record of each asset may indicate how long each asset has been used from an installation of the each asset to a failure of the each asset.

Returning to FIG. 2, at 235, the computing system performs an opportunity cost analysis, e.g., based on the computed failure risk and the determined dependency between the one asset and the one or more of the other assets. The opportunity cost analysis includes, but is not limited to: (1) determining how much cost can be saved by inspecting the one asset or the one or more of the other assets when the computed failure risk of the one asset or the one or more of the other assets becomes larger than a threshold, e.g., more than 70% possibility of failure within a month; and (2) determining a cost to inspect the one asset or the one or more of the other assets in order to predict or estimate a residual life (i.e., remaining life) of the one asset or the one or more of the other assets based on knowledge of a user (e.g., an inspector, etc.) who performs the inspection.

At 245, the computing system schedules a preventive maintenance of the one asset or the one or more of the other assets (e.g., a preventive maintenance of each asset 115 shown in FIG. 1) according to the computed failure risk of the one asset or the one or more of the other assets and further according to the determined cost to inspect the one asset or the one or more of the other assets, i.e., cost constraints. For example, the computing system schedules maintenance of the one asset when the computed failure risk of the one asset becomes larger than a threshold, e.g., more than 70% possibility of failure within a short time range, e.g., a month. According to the preventative maintenance schedule, users may inspect the one asset or the one or more of the other assets.

At 230, in order to perform a service expectation analysis, the computing system runs, based on the received data 215 (e.g., network infrastructure information 205, etc.), a demand forecasting tool that forecasts one or more of: utility (e.g., water, gas, etc.) demand and utility availability. The network infrastructure information may indicate the number of users using the utility and the average number of the new users added every year. An example of a service expectation would be, for example, forecasted utility demand in next year.

After performing the service expectation analysis 230, the computing system performs a service performance evaluation 250. The service performance evaluation 250 includes, but is not limited to: (1) tracking one or more inspections performed on asset(s) in a physical network; (2) counting the number of failures of the asset(s) in the physical network; and (3) receiving, from users, electronic messages that describe complaints associated with utility delivered by the assets in the physical network. The computing system performs the service performance evaluation in order to reduce the number of complaints associated with utility delivered by the assets in the physical network, e.g., by increasing a service quality associated with the asset(s).

At 255, the computing system schedules a long-range plan, e.g., a yearly schedule for replacements of the one asset or the one or more of the other assets based on one or more of: the predicted failure risk of the one asset, the scheduled preventive maintenance, and the service performance evaluation. For example, the computing system may schedule a replacement of the one asset, e.g., before a time period during which the one asset is predicted to be failed according to the hazard function described above. As another example, the computing system may schedule a replacement of the one asset if users associated with the one asset have submitted many complaints whose numbers are more than a threshold (e.g., 100, etc.).

At 260, based on the scheduled replacement, the computing system may plan upgrading a physical network associated with the one asset and the one or more of the other assets. For example, instead of scheduling to replace only the one asset, the computing system may schedule to replace a segment of the physical network associated with the one asset. At 265, the computing system determines a budget associated with replacing or repairing or inspecting the one asset and the one or more of the other assets, e.g., based on the received data 205. For example, the received data 205 may include a specification of the one asset that provides information of price of the one asset. As another example, based on the prior maintenance record 210 of the one asset, the computing system may obtain an average cost (e.g., labor cost, parts cost, etc.) to replace the one asset or the one or more of the other assets. At 270, the computing system may order, e.g., by using an on-line hardware store, parts needed to replace or repair the one asset or the one or more of the other assets.

By running the method shown in FIG. 2, the computing system can predict a failure risk of an asset, e.g., by solving the hazard function described above. Based on the predicted failure risk of the asset, the computing system can estimate service duration of the asset. For example, the solution of the hazard function may indicate a failure risk of an asset during a particular time period. Then, the computing system may determine that that asset may need to be replaced before that particular time-period if the indicated failure risk of that asset is higher than a pre-determined threshold, e.g., 70%.

In one embodiment, there is provided for a method, a system and a computer program product for maintaining a network. The computing system receives data associated with a one network and other networks to which the one network is directly or indirectly physically connected. The computing system determines, based on the received data, a dependency between the one network and one or more of the other networks, e.g., by using the hazard function describe above, where i and j indicate two adjacent networks connected each other. The computing system predicts, based on the determined dependency, a failure of the one network within a future time period, e.g., by solving the hazard function. The solution of the hazard function may indicate that a failure risk of the one network i at the future time period t according to a failure risk of an adjacent network j at the future time period t and a spatial distance between the one network i and the adjacent network j.

In another embodiment, the method shown in FIG. 2 may be implemented as hardware on a reconfigurable hardware, e.g., FPGA (Field Programmable Gate Array) or CPLD (Complex Programmable Logic Device), by using a hardware description language (Verilog, VHDL, Handel-C, or System C). In another embodiment, the methods shown in FIG. 2 may be implemented on a semiconductor chip, e.g., ASIC (Application-Specific Integrated Circuit), by using a semi custom design methodology, i.e., designing a semiconductor chip using standard cells and a hardware description language.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1.-13. (canceled)

14. A system for maintaining an asset, the method comprising:
a memory device;
a processor coupled to the memory device, wherein the processor is configured to perform:
receiving data associated with an one asset and other assets to which the one asset is directly or indirectly physically connected;
determining, based on the received data, a dependency between the one asset and one or more of the other assets; and
predicting, based on the determined dependency, a failure of the one asset within a future time period.

15. The system according to claim 14, wherein the one asset includes one or more of:
a fire hydrant, a pipeline, or a valve.

16. The system according to claim 14, wherein the one asset includes a subset of assets.

17. The system according to claim 14, wherein in order to determine the dependency, the processor is configured to perform:
determining at least one spatial constraint or at least one temporal constraint associated with the one asset and the one or more of the other assets.

18. The system according to claim 17, wherein the determined at least one spatial constraint includes one or more of: geographical locations of the one asset and the other assets, a distance between the one asset and the one or more of the other assets, a physical connection between the one asset and the one or more of the other assets.

19. The system according to claim 14, wherein the determining the dependency comprises:
correlating a failure and an operation of the one or more of the other assets to a failure risk of the one asset.

20. The system according to claim 14, wherein in order to determine the dependency, the processor is configured to perform:
conducting a network flow analysis or a minimum-cut-set analysis on the received data.

21. The system according to claim 19, wherein in order to determine the dependency, the processor is configured to perform:
computing a hazard function associated with the one asset according to hᵢ(t)=hⱼ(t)ƒ(δ(Dᵢⱼ)), where i indicates an identification of the one asset, j indicates an identification of another asset among the other assets, t indicates the future time period, h ( ) is a hazard function, ƒ ( ) is a function whose output is a positive value, δ ( ) is a function that associates a spatial distance between the one asset and the another asset with the failure risk of the one asset.

22. The system according to claim 21, wherein in order to predict the failure of the one asset, the processor is configured to perform:
computing the failure risk of the one asset i at the future time period t according to a failure risk of the another asset j at the future time period t and the spatial distance between the one asset i and the another asset j.

23. The system according to claim 17, wherein in order to determine the at least one temporal constraint, the processor is configured to perform one or more of:
(1) measuring an impact on the one asset from a failure of the one or more of the other assets within a pre-determined time period; or
(2) correlating a failure pattern of the one asset and a failure pattern of the one or more of the other assets based on a sequence of operations on the one asset and the one or more of the other assets.

24. A system for maintaining a network, the method comprising:
a memory device;
a processor coupled to the memory device, wherein the processor is configured to perform:
receiving data associated with an one network and other networks to which the one network is directly or indirectly physically connected;
determining, based on the received data, a dependency between the one network and one or more of the other networks; and
predicting, based on the determined dependency, a failure of the one network within a future time period.

25. A computer program product for maintaining an asset, the computer program product comprising a storage medium that excludes a propagating signal, the storage medium readable by a processing circuit and storing instructions run by the processing circuit for performing a method, said method steps comprising:
receiving data associated with an one asset and other assets to which the one asset is directly or indirectly physically connected;
determining, based on the received data, a dependency between the one asset and one or more of the other assets; and
predicting, based on the determined dependency, a failure of the one asset within a future time period.
